(19) United States
(12) Patent Application Publication
(10) Pub. No.: US 2026/0130398 A1
(43) Pub. Date: May 14, 2026

(54) PUFFED HIGH PROTEIN OAT-BASED FOOD PIECES AND METHODS OF MAKING

(71) Applicant: GENERAL MILLS, INC., Minneapolis, MN (US)

(72) Inventors: Lynn K. Barton, St. Louis Park, MN (US); Caleb Heck, Champlin, MN (US); Abigail Krentz, Minneapolis, MN (US); Xia Liu, Maple Grove, MN (US); Michelle Mander, Plymouth, MN (US); Jesse Mortensen, Coon Rapids, MN (US); Claire Randolph, Robbinsdale, MN (US); Zoran Talijan, Wayzata, MN (US); Goeran Walther, Plymouth, MN (US)

(73) Assignee: GENERAL MILLS, INC., Minneapolis, MN (US)

(21) Appl. No.: 19/388,091

(22) Filed: Nov. 13, 2025

Related U.S. Application Data
(60) Provisional application No. 63/720,426, filed on Nov. 14, 2024.

(51) Int. Cl. A23L 7/165; A23L 7/122; A23L 7/126; A23L 7/191

(52) U.S. Cl. CPC A23L 7/165; A23L 7/122; A23L 7/126; A23L 7/191

(57) ABSTRACT

The present disclosure relates to low density, high protein, oat-based ready-to-eat food pieces, compositions including such food pieces, and methods of making such food pieces. The pieces include oat flour as a first ingredient, about 30% to about 40% by dry weight protein, where at least a portion of the protein ingredients include a protein with a PDCAAS greater of at least 60%, such as pea protein or soybean protein, and 0% to less than 6% maltodextrin.

### CROSS-REFERENCE TO RELATED APPLICATIONS

This application claims the benefit of and priority to U.S. Provisional Application No. 63/720,426, filed Nov. 14, 2024, which is incorporated herein by reference.

### TECHNOLOGY

The present disclosure generally relates to high protein, oat-based RTE food pieces with low density and methods of making such a product.

### BACKGROUND

High protein food products have found popularity among consumers as a way to eat nutritionally dense foods. Consumers want diverse ways to get increased protein into their diets. Thus, there is a need for new high protein food products to satisfy the increasing consumer desire for protein.

### SUMMARY

Methods of making low density, high protein, oat-based ready-to-eat (RTE) food pieces are provided herein, as well as such RTE food pieces and compositions comprising such food pieces.

A method of making shelf stable, ready-to-eat (RTE) food pieces can include mixing and heating ingredients with water to form a dough having a moisture content of about 30% to about 38% by weight of the dough; forming the dough into dough pieces; adjusting the moisture content of the dough pieces to form dried pieces having a moisture content of about 12% to about 25% by weight of the dried pieces; exposing the dried pieces to a pressure of at least 80 psi; rapidly releasing the pressure to produce puffed pieces having a moisture content of less than 15% by weight of the puffed pieces; and drying the puffed pieces to produce the RTE food pieces having a moisture of less than 5% by weight of the RTE food pieces, the RTE food pieces having a bulk density of about 100 to about 200 g/100 cu inch and a protein content of at least 27% by dry weight of the RTE food pieces.

Ingredients in a dough can, in some embodiments, include oat flour in an amount of about 30% to about 60% by dry weight of the dough; a plant-based protein ingredient in an amount of about 28% to about 45% by dry weight of the dough, the protein ingredient having a protein content of at least 60% protein by dry weight of the protein ingredient and comprising pea protein, fava bean protein, lentil protein, wheat protein, oat protein, rice protein, chickpea protein, canola protein, and/or soybean protein; about 3% to about 25% starch ingredient by dry weight of the dough; 0% to less than 6% maltodextrin by dry weight of the dough; and up to 15% other ingredients by dry weight of the dough.

In some embodiments, a method of making shelf stable, RTE food pieces can include a dough that includes pea protein, whole grain oat flour, corn starch, tuber starch, and/or legume starch, corn flour, and/or emulsifier. In some embodiments, a dough can include less than 5% other ingredients.

In some embodiments, a method of making shelf stable, RTE food pieces can include coating the puffed pieces or the RTE food pieces.

In some embodiments, a method of making shelf stable, RTE food pieces can produce RTE food pieces contain no gluten, no soybean, and no dairy ingredients. In some embodiments, the RTE food pieces can contain no maltodextrin.

Shelf stable, RTE food pieces and products that include shelf stable, RTE food pieces made according to a method provided herein are also disclosed.

A product that includes shelf stable, RTE food pieces having a protein content of at least 27% by dry weight of the RTE food pieces is also provided herein. In some embodiments of such a product, RTE food pieces can include an oat component in an amount of about 30% to about 60% by dry weight of the RTE food pieces; a plant-based protein component contributing protein in an amount of about 15% to about 45% by dry weight of the RTE food pieces, the plant-based protein component comprising pea protein, fava bean protein, lentil protein, wheat protein, oat protein, rice protein, chickpea protein, canola protein, and/or soybean protein; about 25% to about 70% starch by dry weight of the RTE food pieces; 0% to less than 6% maltodextrin by dry weight of the RTE food pieces; and up to 15% other components by dry weight of the RTE food pieces.

In some embodiments, RTE food pieces in a product provided herein can have a bulk density of about 100 to about 200 g/100 cu inch and a moisture content of less than 5% by weight.

In some embodiments, RTE food pieces in a product provided herein can have a coating on at least a portion of a surface of the food pieces, and the food pieces plus the coating have a bulk density of about 150 to about 350 g/100 cu inch. In some embodiments, RTE food pieces in a product provided herein can be uncoated.

In some embodiments, RTE food pieces in a product provided herein can be aggregated with binder to form clusters or a snack bar.

In some embodiments, RTE food pieces in a product provided herein can contain no maltodextrin. In some embodiments, RTE food pieces in a product provided herein can contain no gluten, no soybean, and no dairy ingredients.

These and various other features and advantages will be apparent from a reading of the following detailed description.

### DETAILED DESCRIPTION

Consumers continually expect an even greater variety of high protein foods that are suitable for different eating occasions. However, protein ingredients, particularly non-animal derived protein ingredients, often suffer from bitter taste, astringency, and/or off-flavor/aroma, and have proven difficult to puff or to produce a product that resembles a traditional ready-to-eat (RTE) grain-based breakfast cereal. Thus, while grain-based RTE cereal products are available with supplemental protein content (i.e., protein content beyond that contributed by the grain-based component(s)), such products leverage different formats (e.g., flakes, nugget-type pieces, or twigs) or have structures that are generally denser and often have a harder, crunchier, grittier, and/or glassier texture when attempting to replicate traditional puffed RTE cereal format than traditional RTE grain-based breakfast cereals. Such products also tend to suffer from off-flavors and/or bitterness. The present application describes the discovery of high protein compositions that can be puffed into a low-density, high protein, RTE food piece having a pleasant, crunchy texture resembling traditional grain-based RTE breakfast cereal, and having a pleasant or neutral flavor, even in the absence of flavorants or off-flavor maskers.

It was previously discovered that a high protein, low density, and RTE grain-based food piece can be made with the inclusion of maltodextrin (see, U.S. Provisional Patent Application 63/625,486). However, formulating a high protein puffed grain-based RTE food piece without maltodextrin proved difficult, especially for a cereal with a high oat ingredient content because both oat ingredients and protein ingredients tend to inhibit puffing. Many RTE breakfast cereals are produced by direct expansion from an extruder because of the versatility in types of ingredients, levels of puffing, and types of products that can be achieved using direct expansion from an extruder. However, it was found that a high protein, oat-based food piece with desired texture and appearance with a targeted low density could not be produced without maltodextrin by direct expansion from an extruder. The present application describes the discovery of a new method that can produce a high protein, puffed, oat-based food piece with little (i.e., less than 6% by dry weight) or even no maltodextrin.

A method provided herein produces a high protein, low density, and ready-to-eat oat-based food piece. As used herein, the term “high protein” refers to a food piece that includes protein in an amount of about 27% to about 40% by dry weight of the piece (e.g., at least 28% to about 38%) by dry weight of the food piece. The term “low density” refers to a plurality of food pieces that has a bulk density of about 100 to about 200 (e.g., about 140 to about 180, or about 150 to about 170) g/100 cubic inches. A low density food piece may also be referred to as “puffed.” The term “oat-based” refers to a food piece that contains oat flour (e.g., whole grain oat flour) as the most abundant ingredient by dry weight of the food piece (i.e., oat flour is the “first ingredient”).

As used herein, the term “ready-to-eat” (“RTE”) refers to a food that does not require further cooking or preparation to be suitable and safe for consumption. A food piece provided herein is typically also shelf stable at room temperature for at least 6 months (e.g., at least 8 months, or 12 months to 18 months) without significant negative impact on texture, structure, or flavor when stored in appropriate packaging. A food piece provided herein typically has dimensions that are suitable for a RTE breakfast cereal or a bite sized snack food. A food piece provided herein can also be suitably coated, or it can be used in other products, such as dry snacks, inclusions to be mixed in other products (e.g., yogurt or pudding), snack blends, cold-formed or baked snack bars or clusters.

A method provided herein includes mixing and heating ingredients with water to form a dough having a moisture content of about 30% to about 38% (e.g., about 32% to about 35%) by weight of the dough. The dough is formed into dough pieces, dried and then puffed using a puffing gun. Product made from dough with moisture levels below 32% can be acceptable, but begin to exhibit reduced quality, such as reduced puffing, increased off-flavors, and undesirable appearance. Product made from dough with moisture levels below 30% produce product that has unacceptably poor flavor, hard texture, and high density. Doughs having moisture levels above 35% can produce acceptable product, but are more difficult to form into dough pieces due to stickiness and are more likely to deform prior to puffing, which can result in irregular product shapes. Doughs having moisture levels above 38% are difficult to shape and dry to moisture levels suitable for puffing. Moisture levels in a range suitable for the methods described herein were too high to be compatible with direct expansion from an extruder, and direct expansion extrusion at lower moisture levels resulted in unacceptable product. See, the Examples, below.

Ingredients included in a dough consist of oat flour, a plant-based protein ingredient, starch ingredient, less than 6% (e.g., less than 2%, or 0%) by dry weight maltodextrin, and up to 15% (e.g., 0% to 14%, 0% to 10%, or 0% to 8%) other ingredients. Oat flour can be included in a dough in an amount of from about 30% to about 60% (e.g., about 40% to about 60%, or about 50% to about 60%) by dry weight of the dough. As used herein, oat flour refers to a food ingredient obtained by grinding oats. Oat flour includes, for example, whole grain oat flour, oat bran, refined oat flour, and the like, or combinations thereof. Oat flour is not limited to finely ground flours, and can include coarse flours. However, an oat flour referred to herein does not refer to isolated and/or extracted starch, such as a starch ingredient described below.

A plant-based protein ingredient can be included in a dough in an amount of about 28% to about 45% (e.g., about 30% to about 40%) by dry weight of the dough. A plant-based protein ingredient may have at least a portion (e.g., at least 60%, at least 70%, or at least 90%) of its protein content comprising a protein source that has a suitable protein digestibility-corrected amino acid score (PDCAAS). Examples of such proteins include, without limitation, soybean protein, which typically has a PDCAAS of about 90% to about 100%, pea protein, which typically has a PDCAAS of at least 60%, chickpea protein, which typically has a PDCAAS of at least 70%, quinoa protein, which typically has a PDCAAS of at least 60%, and rapeseed/canola protein, which typically has a PDCAAS of at least 80%. PDCAAS of a protein is calculated according to the Food and Agriculture Organization of the United Nations (Joint FAO/WHO Expert Consultation (1990), Protein Quality Evaluation. Report of a Joint FAO/WO Expert Consultation held in Bethesda, MD, USA, 4-8 Dec. 1989. Food and Agriculture Organization, Rome. Section 8. ISBN 92-5-103097-9).

In some embodiments, a plant-based protein ingredient comprises a legume protein (e.g., soybean protein, pea protein, chickpea protein, fava bean protein, lentil protein, and the like). In some embodiments, a plant-based protein ingredient can include protein from a non-legume plant source, such as wheat, rice, corn, canola, oat, and the like. In some embodiments, a plant-based protein ingredient can be selected to avoid common allergens. For example, soybean protein and/or wheat protein can be avoided for soy-free and/or gluten-free products, respectively.

In some embodiments, a plant-based protein ingredient can have a protein content of at least 60% (e.g., at least 65%) by dry weight of the protein ingredient. In some embodiments, a plant-based protein ingredient can have a protein content that consists of soybean protein, pea protein, canola protein, chickpea protein, or any combination thereof. A plant-based protein ingredient can comprise, for example, legume flours (e.g., soybean flour or the like), protein concentrates (e.g., soybean protein concentrate, pea protein concentrate, fava bean protein concentrate, canola protein concentrate, chickpea protein concentrate, or the like), protein isolates (e.g., soybean protein isolate, pea protein isolate, chickpea protein isolate, or the like), and the like, or any combination thereof.

A protein ingredient having at least a portion of the protein content comprising a legume protein can contribute to a texture that closely resembles a traditional grain-based RTE cereal. In contrast, a similarly formulated food piece that includes wheat protein and no legume protein can result in a texture that is harder, more brittle, grittier, and/or glassier than a food piece described herein.

A plant-based protein ingredient can contribute protein in an amount of about 20% to about 42% (e.g., about 25% to about 40%) by dry weight of a food piece. In some embodiments a plant-based protein ingredient can be selected to arrive at a total protein content that delivers high quality protein in an amount of at least 10% (e.g., at least 11%, or about 11% to about 15%) by dry weight of a food piece. As used herein, the amount of high quality protein in a food piece can be calculated by multiplying the amount of protein contributed by all ingredients by the PDCAAS score of the food piece. For example, if the protein content of the food piece is 20%, and the PDCAAS value of the food piece is 60%, then the amount of high quality protein in the food piece is about 12% (0.2×0.6=0.12, or 12%). Total protein in a food piece provided herein ranges from about 28% to about 45% (e.g., about 28% to about 42%, or about 32% to about 40%) by dry weight of the food piece, and includes protein content combined from all of the included ingredients (e.g., protein ingredient and oat flour).

A starch ingredient can be included in a dough in an amount of about 3% to about 25% (e.g., about 5% to about 12%, or about 6% to about 10%) by dry weight of the dough. As used herein, a “starch ingredient” refers to starch that is isolated and/or extracted from a starch source (e.g., a grain, a tuber, a legume, a fruit, or the like). A starch ingredient is typically at least 95% native and/or modified starch by dry weight of the ingredient. Suitable starch ingredients include, for example, corn starch, pea starch, wheat starch, potato starch, manioc starch, and the like, or any combination thereof. Total starch in a food piece provided herein ranges from about 25% to about 70% (e.g., about 28% to about 65%, or about 30% to about 45%) by dry weight of the food piece, and includes starch content combined from all of the included ingredients (e.g., starch ingredient, oat flour, and protein ingredient).

Maltodextrin can be included in a dough in an amount of less than 6% (e.g., less than 2%, or 0%) by dry weight of the dough. Although maltodextrin can enable the production of high protein, grain-based RTE food pieces made from doughs that have lower moisture contents (e.g., from about 8% to about 20%) than those disclosed herein, the methods described herein do not require the inclusion of maltodextrin. Thus, the methods described herein can, in some preferred embodiments, exclude maltodextrin. Using little or no maltodextrin in the described methods beneficially enables inclusion of higher protein and/or higher oat content without sacrificing flavor, texture, and appearance of the resulting RTE food pieces.

Oat flour, plant-based protein ingredient, starch ingredient, and optional maltodextrin comprise at least 85% (e.g., at least 90%) by dry weight of a dough provided herein. Additional other ingredients can optionally be included in a combined amount of up to 15% (e.g., less than 14%, less than 10%, or up to 5%) by dry weight of a dough. For example, a sweetener (e.g., sugar, sugar alcohol, high potency sweetener, or the like) can be included to contribute to flavor/sweetness and/or structure or texture; colorants and/or flavorants (e.g., salt, vanilla, cocoa, cinnamon, natural and/or artificial coloring, or the like) to provide a desired appearance or flavor; animal-derived protein ingredients (e.g., casein or caseinate, whey protein, milk powder, egg, and the like) to provide flavor, texture, and/or nutritional benefits; non-oat flour (e.g., a grain flour, a nut flour, a tuber flour, or the like) to provide flavor, texture, and/or nutritional benefits; and/or minors, such as vitamins, minerals, calcium carbonate, processing aids (e.g., emulsifiers, dough conditioners, and the like), pH modifiers, and the like, or any combination thereof.

In some embodiments, an emulsifier (e.g., mono- and/or diglycerides, lecithin, and the like) can be included (e.g., in an amount of about 0.1% to about 1%, or about 0.15% to about 0.8%, or about 0.2% to about 0.5% by dry weight) in a dough provided herein to reduce breakage during manufacture (e.g., during puffing, conveying, packaging, and the like), shipping, and/or storage. While not essential for making a high protein, oat-based food piece with desirable flavor and texture attributes, in some embodiments, including an emulsifier can significantly reduce the amount of fines created during production (e.g., by at least 20%, or at least 40%).

In some embodiments, a dough can be formulated to exclude certain ingredients to produce RTE food pieces that provide certain dietary or nutritional needs. For example, RTE food pieces provided herein can contain no gluten, soybean, nut, egg, dairy, and/or animal-derived ingredients.

A non-oat flour referred to herein can be a whole grain flour or a refined flour, however, a non-oat flour referred to herein does not refer to isolated and/or extracted starches. Non-oat flour is not limited to finely ground flours, and can include coarse flours, such as corn meal or corn cones.

Mixing and heating can be performed at a dough temperature of at least 180° F. (e.g., about 190° F. to about 280° F., about 200° F. to about 270° F.) for at least 30 seconds (e.g., about 90 seconds to about 1 hour, or about 2 minutes to about 45 minutes). The temperature, time, and mixing conditions can be adjusted as appropriate to form a dough. For example, a mixing process can be performed at a higher temperature (e.g., about 230° F. to about 280° F.) for a short time (e.g., about 30 seconds to about 5 minutes, or about 90 seconds to about 3 minutes), or at a low temperature (e.g., at least 180° F. to about 230° F., or about 200° F. to about 225° F.) for a longer period of time (e.g., about 20 minutes to about 1 hour, or about 25 minutes to about 45 minutes). It is believed that there are many types of equipment capable of producing a suitable dough, so long as sufficient dough moisture is achieved and a cohesive dough is formed. Without being bound by theory, it is believed that the dough moisture described above provides sufficient hydration of both the protein and the starch in the dough to produce a structure during puffing that is pliable enough to expand without shattering, yet becomes rigid quickly enough after puffing to result in a low density, pleasantly textured food piece resembling a traditional RTE breakfast cereal.

A dough can be formed into dough pieces using any appropriate method. For example, a dough can be extruded from a die (but not significantly puffed) and pinched or cut into dough pieces, sheeted and cut into dough pieces, pressed into molds, or the like. The dough pieces can be any suitable shape, such as spheres, o-shapes, letters/numbers, squares, symbols, or the like.

The moisture content of the dough pieces is then adjusted to about 11% to about 25% (e.g., about 12% to about 20%) by weight using, for example, an oven or a dryer to form dried pieces.

It was discovered, however, that dried pieces do not sufficiently puff during toasting or drying at standard atmospheric pressure, even at moisture levels different from those above. Thus, a method provided herein includes exposing dried pieces to high pressure (e.g., at least 80 psi, at least 85 psi, or about 90 psi to about 200 psi), optionally at elevated temperature, followed by rapid release of the pressure to produce puffed pieces (i.e., “gun puffed”). Any suitable method and equipment can be used to puff the dried pieces. For example, dried pieces can be gun-puffed using manual, automatic, or continuous puffing guns (e.g., single-shot guns, batch puffing guns, or the like). Generally, gun puffing causes trapped moisture in the dried pieces to change very rapidly from the liquid state to the vapor phase by sudden release of pressure, causing cells to form and/or expand in the pieces. Puffed pieces typically have a moisture content of less than 10% (e.g., about 4% to about 8%, or about 5% to about 7%) by weight.

Puffed pieces are then dried to a moisture of less than 5% (e.g., 1% to about 4%, or about 2% to about 3.5%) to produce RTE food pieces. RTE food pieces can have a bulk density of about 100 to about 200 g (e.g., about 140 to about 180 g) per 100 cubic inches.

In some embodiments, RTE food pieces provided herein can have average diameter of from about 8 mm to about 20 mm (e.g., from about 10 mm to about 15 mm). However, the size of a food piece can be adjusted for the desired use of the food piece or to provide a manufacturing advantage. For example, the size of a food piece can be adjusted to provide a desired size for eating as a stand-alone RTE breakfast cereal or snack, or for use as a component in a snack bar or snack mix. In another example, the size of a food piece can be adjusted to result in a desired drying time during manufacturing.

In some embodiments, puffed pieces can be coated before drying, but RTE food pieces can also be coated after drying. For example, a sugar-based, sugar alcohol-based, or fat-based coating (e.g., nut butter-based, seed butter-based, chocolate-based, compound coating-based, or the like) can be applied on at least a portion of a surface of a puffed piece or a RTE food piece to modify the taste, texture, bowl life (e.g., in a bowl of milk), nutritional profile, and/or appearance of the food piece. In another example, a puffed piece or RTE food piece can be sprayed with oil and a dry seasoning (e.g., cinnamon, sugar, chili, oregano, cocoa powder, or the like, or any combination thereof) can be dusted onto the surface. A coating in a composition of coated food pieces provided herein can typically comprise about 10% to about 50% (e.g., about 30% to about 50%) by weight of the composition. It is to be understood that bulk density of RTE food pieces described above does not include a coating, and that a coating can increase the apparent bulk density of RTE food pieces (e.g., to about 150 g to about 350 g per 100 cubic inches).

Also provided herein are compositions comprising a plurality of food pieces provided herein. In some embodiments, a composition can contain edible components other than the food pieces provided herein. For example, a composition can comprise dried fruit, nuts, confectionery pieces, crisps, other grain-based pieces, protein-based pieces, or the like. In some embodiments, a composition can comprise coated food pieces provided herein. A composition comprising coated food pieces can contain pieces that are partially or entirely coated and, in some cases, uncoated pieces as well as coated pieces.

In some embodiments, RTE food pieces provided herein can be packaged and sold as a food product without any other components. Such packaged food pieces can be intended to be eaten as a food product alone or in combination with other food products. For example, food pieces can be packaged and sold as a snack, or as part of a RTE breakfast cereal. In some embodiments, a food piece can be adhered with one or more edible components, such as another food piece, nut pieces, fresh or dried fruit pieces, seeds, coconut, grain, and the like, to form a cluster or bar. A food piece and one or more edible components can be adhered to each other using any appropriate method and ingredients (e.g., edible binders and the like). For example, a cluster can be produced using a combination of a food piece and rolled oats adhered using a honey-based binder or slurry. Clusters can be provided as a food product alone or as part of a food product, such as a snack mix, ready to eat cereal, or oatmeal mix.

It is to be understood that food pieces provided herein can be used for either sweet or savory applications in food. Food pieces disclosed herein can provide a benefit of being a high protein stand-alone food product or provide added protein in combination with other components in food products while also providing an improved texture and flavor over other known high protein pieces.

### EXAMPLES

### Example 1

Samples were prepared according to Table 1. A pea protein concentrate (about 80% protein by dry weight) was included as the plant based protein ingredient. Minors included salt, calcium carbonate, tripotassium phosphate, and flavor. Doughs were made at moisture contents ranging from about 27% to about 34%, and puffs were made from dried pieces using a puffing gun. The moisture of the dried pellets prior to puffing was about 12% to about 20%. Densities and notes in Table 1 describe uncoated puffed RTE food pieces.

TABLE 1

| | Formulation | | | | |
|---|---|---|---|---|---|
| Ingredient | Control | 1 | 2 | 3 | 4 |
| Oat flour | 90-95% | 52-55% | 42-45% | 52-55% | 52-55% |
| Protein ingredient | 0% | 32-35% | 42-45% | 32-35% | 32-35% |
| Starch ingredient | 3-6% | 5-10% | 5-10% | 5-10% | 5-10% |
| Dough moisture | 26-28% | 32-34% | 32-34% | 27-28% | 33-34% |
| Minors | 2-3% | 4-6% | 4-6% | 4-6% | 4-6% |
| Dried piece moisture | 10-12% | 12-14% | 12-14% | 13-14% | 19-20% |
| Density | 160-170 | 130-170 | 160-170 | 320 | 110-120 |
| Notes | Crispy, crunchy, | Similar to control, | Similar to control, | Dough pieces | Lighter, |
| | pleasant oat | slightly less oat | acceptable levels of | appeared under- | crispier |
| | flavor | flavor, some | pea protein flavor | cooked, did | than Form. 1 |
| | | savory notes | | not puff | |

The Control formulation included no protein ingredient, with minors including salt, calcium carbonate, and tripotassium phosphate or trisodium phosphate. The Control formulation generally required lower moisture in the dough than in formulations that contained protein ingredient to produce a good product. In contrast, a high protein formulation with a similar dough moisture as control (Formulation 3) did not puff sufficiently, which resulted in hard, dense food pieces. Formulation 1 produced food pieces very similar to Control in texture, with a good flavor. Although samples in Formulation 1 were all acceptable, as moisture levels in the dried pieces decreased, puffing was reduced and perceived hardness increased. Samples made from Formulation 2, which had a higher protein content than Formulation 1, were similar in texture and flavor to Formulation 1 with the addition of a slight pea protein flavor Formulation 4 produced food pieces that were slightly less dense than Control and Formulation 1, with a light, crispy texture.

Samples were also made that optionally included mono- and diglycerides, corn meal, as shown in Table 2. Plant based protein ingredient, and minors were the same as in Formulations 1-4.

TABLE 2

| | 5 | 6 | 7 |
|---|---|---|---|
| Oat flour | 32-35% | 45-48% | 52-55% |
| Protein ingredient | 42-45% | 32-35% | 32-35% |
| Starch ingredient | 5-10% | 3-6% | 5-10% |
| Dough moisture | 32-34% | 30-34% | 33-34% |
| Minors | 4-6% | 4-6% | 4-6% |
| Other | 10-14% corn meal | 10-14% corn meal | 0.2-0.5% mono- and |
| | | | di-glycerides |
| Dried piece moisture | 12-14% | 13-14% | 13-14% |
| Density | 160-170 | 150-170 | 160-170 |
| Notes | Similar to control, | Similar to control, | Similar to control, |
| | acceptable levels of | slight savory notes, | acceptable levels of pea |
| | pea protein flavor | acceptable levels of | protein flavor, reduced |
| | | pea protein flavor | breakage relative to |
| | | | Formulation 1 |

Samples made from Formulation 5, which had a higher protein content than Formulation 1, and included corn meal, had a similar flavor and texture to Formulation 2. Samples made from Formulation 6 were similar to Formulation 5. Samples made from Formulation 7 were similar to Formulation 1, but with reduced breakage relative to Formulation 1 during production.

### Example 2

Samples were produced in a twin-screw extruder for direct expansion with a formulation that included 52-55% whole grain oat flour, 32-35% pea protein concentrate, 5-10% corn starch, 4-6% minors, and no maltodextrin, similar to Formulation 1 in Table 1. The moisture content of the dough produced in the twin screw extruder was adjusted from about 16% to about 30%. At a moisture level of about 16-17%, some puffing was observed, but the pieces shattered during expansion and the density remained unacceptably high (about 230-240 g/100 cubic inches). At dough moistures above 17%, little to no direct expansion was observed, resulting in pieces with densities exceeding 300 g/100 cubic inches, and moisture levels that were too high to be suitable for further processing.

The implementations described above, and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A method of making shelf stable, ready-to-eat (RTE) food pieces, the method comprising:
a. mixing and heating ingredients with water to form a dough having a moisture content of about 30% to about 38% by weight of the dough, the ingredients consisting of:
i. oat flour in an amount of about 30% to about 60% by dry weight of the dough;
ii. a plant-based protein ingredient in an amount of about 28% to about 45% by dry weight of the dough, the protein ingredient having a protein content of at least 60% protein by dry weight of the protein ingredient and comprising pea protein, fava bean protein, lentil protein, wheat protein, oat protein, rice protein, chickpea protein, canola protein, soybean protein, or combinations thereof;
iii. about 3% to about 25% starch ingredient by dry weight of the dough;
iv. 0% to less than 6% maltodextrin by dry weight of the dough; and
v. up to 15% other ingredients by dry weight of the dough;
b. forming the dough into dough pieces;
c. adjusting the moisture content of the dough pieces to form dried pieces having a moisture content of about 12% to about 25% by weight of the dried pieces;
d. exposing the dried pieces to a pressure of at least 80 psi;
e. rapidly releasing the pressure to produce puffed pieces having a moisture content of less than 15% by weight of the puffed pieces; and
f. drying the puffed pieces to produce the RTE food pieces having a moisture content of less than 5% by weight of the RTE food pieces, the RTE food pieces having a bulk density of about 100 to about 200 g/100 cu inch and a protein content of at least 27% by dry weight of the RTE food pieces.

2. The method of claim 1, wherein the oat flour comprises whole grain flour.

3. The method of claim 1, wherein the starch ingredient comprises corn starch, tuber starch, legume starch, or combinations thereof.

4. The method of claim 1, wherein the other ingredients comprise corn flour.

5. The method of claim 1, wherein the other ingredients comprise emulsifier.

6. The method of claim 1, wherein the ingredients include less than 5% other ingredients.

7. The method of claim 1, comprising coating the puffed pieces or the RTE food pieces.

8. The method of claim 1, wherein the RTE food pieces contain no gluten, no soybean, and no dairy ingredients.

9. The method of claim 1, wherein the plant-based protein ingredient comprises pea protein.

10. The method of claim 1, wherein the RTE food pieces contain no maltodextrin.

11. A product comprising shelf stable, RTE food pieces made according to a method of claim 1.

12. A product comprising shelf stable, RTE food pieces having a protein content of at least 27% by dry weight of the RTE food pieces, RTE food pieces consisting of:
a. an oat component in an amount of about 30% to about 60% by dry weight of the RTE food pieces;
b. a plant-based protein component contributing protein in an amount of about 15% to about 45% by dry weight of the RTE food pieces, the plant-based protein component comprising pea protein, chickpea protein, fava bean protein, lentil protein, wheat protein, oat protein, rice protein, canola protein, soybean protein, or combinations thereof;
c. about 25% to about 70% starch by dry weight of the RTE food pieces;
d. 0% to less than 6% maltodextrin by dry weight of the RTE food pieces; and
e. up to 15% other components by dry weight of the RTE food pieces;
wherein the food pieces have a bulk density of about 100 to about 200 g/100 cu inch and a moisture content of less than 5% by weight of the RTE food pieces.

13. The product of claim 12, wherein the RTE food pieces are uncoated.

14. The product of claim 12, wherein the RTE food pieces have a coating on at least a portion of a surface of the food pieces, and the food pieces plus the coating have a bulk density of about 150 to about 350 g/100 cu inch.

15. The product of claim 12, wherein the RTE food pieces are aggregated with binder to form clusters or a snack bar.

16. The product of any claim 12, wherein the RTE food pieces contain no maltodextrin.

17. The product of claim 12, wherein the RTE food pieces contain no gluten, no soybean, and no dairy ingredients.
